(19) United States
(12) Patent Application Publication
(10) Pub. No.: US 2003/0126329 A1
(43) Pub. Date: Jul. 3, 2003

(54) Apparatus and method for controlling a service control unit of a multi-service system

(75) Inventor: Seung-Wook Jung, Kunpo (KR)

Correspondence Address: FLESHNER & KIM, LLP, P.O. Box 221200, Chantilly, VA, 20153-1200, US

(73) Assignee: LG Electronics Inc.

(21) Appl. No.: 10/329,403

(22) Filed: Dec. 27, 2002

(30) Foreign Application Priority Data
Dec. 27, 2001 (KR) 85713/2001

(51) Int. Cl. G06F 13/00

(52) U.S. Cl. 710/104

(57) ABSTRACT

An apparatus and corresponding method are provided for controlling a service control unit of a multi-service system. The apparatus and method are capable of reading a service unit ID, regardless of an address of each slot or a register address of a service unit, by storing an ID of a service unit using an one way or two way buffer positioned inside the service unit and independently enabling ID output control signals for each slot in a control unit.

### BACKGROUND OF THE INVENTION

1. Field of the Invention

The invention relates to a multi-service system and, more particularly, to an apparatus and method for controlling a service control unit of a multi-service system.

2. Background of the Related Art

Generally, a multi-service system is a system which provides various kinds of services in a system by mounting a plurality of service units in one slot. Such multi-service system provides multiple services which a user wants by controlling the service units of respective slots by recognizing an inherent identification (ID) of the service unit which is mounted in the respective slots.

FIG. 1 is a block diagram showing a conventional multi-service system. As shown in FIG. 1, the conventional multi-service system includes a plurality of slots 10-1˜10-n in which service units (service hardware) 11-1˜11-n are mounted, a control unit 20 for controlling service units 11-1˜11-n of respective slots by an address bus, a data bus, and a control bus.

The service units 11-1˜11-n each include a register for setting or storing the unit's ID, that is, a program gate array (hereinafter, referred to as PGA) 12-1˜12-n. The control unit 20 includes a PGA 20-1 that stores a unit ID read in each of the respective service units 11-1˜11-n, and a CPU 20-2 that controls the service units 11-1˜11-n.

The operation of the conventional multi-service system of FIG. 1 will be described as follows.

To control the service units 11-1˜11-n which are mounted in the respective slots 10-1˜10-n, the CPU 20-2 of the control unit 20 outputs an address to the slots 10-1˜10-n through the address bus. The control unit 20 outputs an address strobe signal (hereinafter, referred to as AS) through the control bus. When the address and AS signal are inputted, the service units 11-1˜11-n of the respective slots 10-1˜10-n check whether the inputted address is the address corresponding to its respective PGA 12-1˜12-n. For example, if the input address is the respective PGA address of the service unit 11-1, the service unit 11-1 reads the ID stored in the corresponding PGA 12˜1 and outputs the ID to the control unit 20 through the data bus. At this time, the service unit 11-1 transmits a data transfer acknowledge signal (hereinafter, referred to as DTACK) through the control bus. The DTACK indicates that normal data is currently outputted to the control unit 20 through the data bus.

When a DTACK signal is inputted from the service unit 11-1, the CPU 20-2 of the control unit 20 receives the ID from the data bus, and stores the ID in its PGA 20-1. The CPU 20-2 reads the ID stored in the PGA 20-1, and provides a preferred multi-service after determining that the ID corresponds to the service unit 11-1. Then, the control unit 20 identifies the kinds/types of the service units 11-2˜11-n which are mounted in the respective slots 10-2˜10-n and provides the multiple service which a user wants.

As described above, the control unit must have the IDs of the respective service units to identify the kinds/types of the service units mounted in the respective slots. To perform the unit ID recognizing operation well, service unit developers must be aware of operation and timing of the signals outputted from the control unit. For instance, a service unit developer must consider time information, including about how many seconds after the control unit receives the IDs must the control unit output a control signal, for how many seconds valid address must be outputted, or for how many seconds the output of the unit ID must be maintained.

Since the conventional multi-service system cannot receive the ID of the service units which it does not directly control through the address bus and data bus due to the structure of the system, parts of the service units may not be recognized. Further, in the conventional multi-service system, the PGA must be used to provide the IDs for units which do not require use of devices such as PGAs, due to the function of the unit. Accordingly, development of the hardware was complicated and manufacturing costs increased.

Also, in the conventional multi-service system, the unit designer must be aware of the operation and timing of the signals outputted from the control unit in the case of adding service units, thus increasing the developing time and the possibility that an error will be generated.

In the conventional multi-service system, when the system is changed, that is, when a new slot is added or a new service unit is added to a slot, the CPU must correct the control program, or modify or develop the control program according to the slot address, number of the slots, unit address, kinds of the unit, and the like. Therefore, in the conventional multi-service system, reusability of the software was degraded when the system was changed.

### SUMMARY OF THE INVENTION

An object of the invention is to solve at least the above problems and/or disadvantages and to provide at least the advantages described hereinafter.

To achieve these and other advantages, in whole or in part, and in accordance with the purpose of the invention, as embodied and broadly described herein, there is provided an apparatus for controlling a service control unit of a multi-service system, including one or more slots, at least one service unit mounted in each of the one or more slots, a control unit configured to read an ID of a respective service unit and individually control the respective service unit, and an interface unit configured to interface a control signal and unit ID between the one or more slots and the control unit.

The service unit may include a one way or two way buffer configured to store the unit ID. The interface unit may include a plurality of control lines which are connected to respective slots and a data bus of predetermined bits, which is commonly connected to the slots.

The control unit may include a programming gate array (hereinafter, referred to as PGA) configured to transmit an ID output control signal of the service unit within a respective slot, and store the unit ID outputted by the service unit. The control unit may further include a CPU configured to enable an output control signal of the unit ID in the PGA, and distinguish the service unit by reading the unit ID stored in the PGA.

To achieve these and other advantages and in accordance with the purpose of the present invention, as embodied and broadly described herein, there is further provided an apparatus for controlling a service control unit of a multi-service system, comprising a plurality of slots in which a service unit is mounted, at least one service unit mounted in each of the plurality of slots, a plurality of control lines individually connected, respectively, to the plurality of slots, a data bus commonly connected to each of the plurality of slots, and a control unit configured to control the at least one service unit mounted in each of the plurality of slots through the control lines and the data bus.

To achieve these and other advantages and in accordance with the purpose of the present invention, as embodied and broadly described herein, there is further provided a method for controlling a service control unit of a multi-service system, the method including enabling an ID output control signal in a first register of a control unit, transmitting the enabled ID output control signal to a slot containing a service unit, transmitting an ID of a service unit to the control unit according to the transmitted ID output control signal, storing the transmitted ID in a second register of the control unit and controlling the corresponding service unit by reading the stored ID.

The first register may include a plurality of slot setting bits corresponding to respective slots, and store the ID output control signal of the service unit. The first and second registers may be automatically initialized when the CPU reads the ID stored in the second register and the respective slot setting bits of the first register are not simultaneously enabled. Further, the service unit may comprise a one way or two way buffer configured to store the ID of the service units and the bits of the first register are not simultaneously enabled.

To achieve these and other advantages and in accordance with the purpose of the present invention, as embodied and broadly described herein, there is further provided a method for controlling service control units of a multi-service system, the multi-service system including a plurality of slots, each containing one or more service units, and a control unit, the method comprising enabling an ID output control signal stored in the control unit, transmitting the enabled ID output control signal to a respective slot, transmitting an ID of a respective service unit corresponding to the ID output control signal to the control unit, storing the transmitted ID in the control unit, and controlling the respective service unit by reading the ID.

To achieve these and other advantages and in accordance with the purpose of the present invention, as embodied and broadly described herein, there is further provided an apparatus for controlling service control units of a multi-service system, the multi-service system including a plurality of slots, each containing one or more service units, the apparatus comprising means for enabling an ID output control signal, means for transmitting the enabled ID output control signal to a respective slot, means for transmitting an ID of a respective service unit corresponding to the ID output control signal to the control unit, means for storing the transmitted ID, and means for controlling the respective service unit by reading the ID.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The invention will be described in detail with reference to the following drawings in which like reference numerals refer to like elements and wherein:

FIG. 1 is a schematic block diagram of a conventional multi-service system;

FIG. 2 is a schematic block diagram of an apparatus for controlling a service unit of a multi-service system in accordance with an embodiment of the invention;

FIG. 3 is a schematic block diagram of the buffer of FIG. 2;

FIG. 4 is a schematic block diagram of the PGA of FIG. 2; and

FIG. 5 is a flow chart explaining a method for reading an ID of the service unit of FIG. 2.

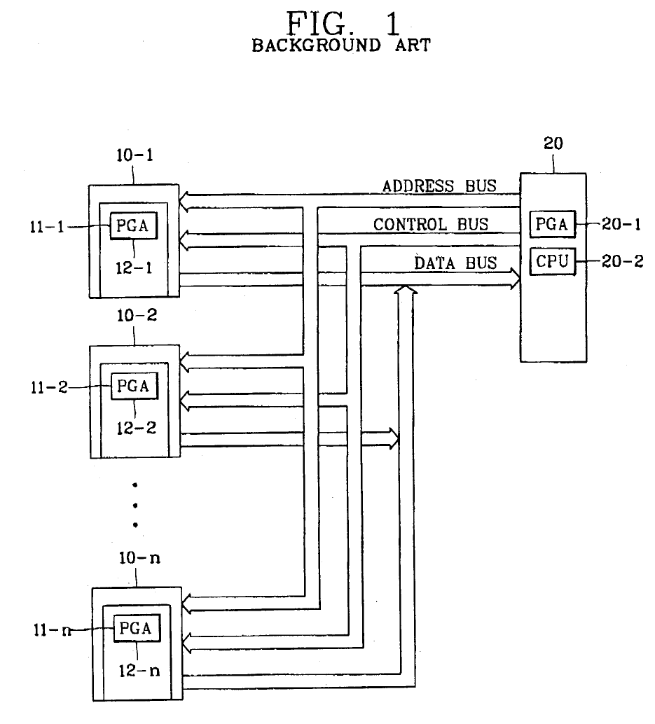

### DETAILED DESCRIPTION OF PREFERRED EMBODIMENTS

Reference will now be made in detail to the embodiments of the invention, examples of which are illustrated in the accompanying drawings.

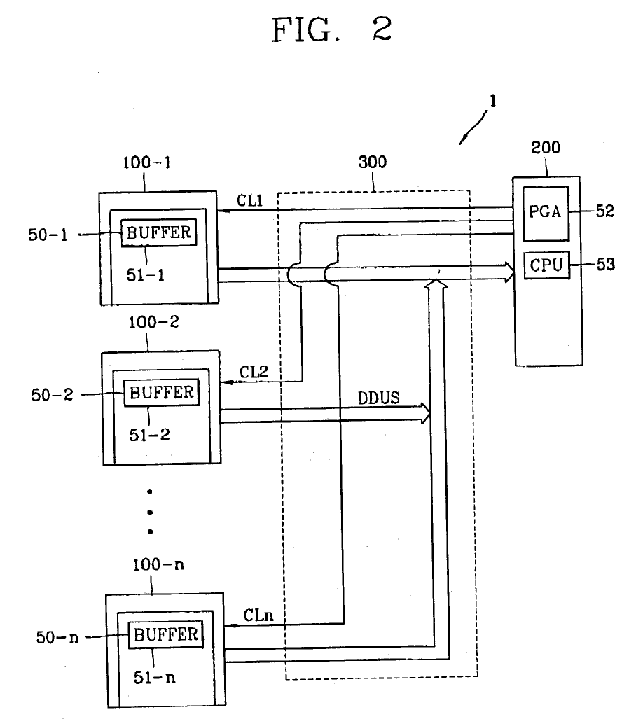

FIG. 2 is a schematic block diagram of an apparatus for controlling a service unit of a multi-service system in accordance with an embodiment of the invention. The service unit control apparatus 1 of the multi-service system of FIG. 2 includes a plurality of slots 100-1˜100-n in which one or more service units 50-1˜50-n are mounted, a control unit 200 configured to control the respective service units 50-1˜50-n mounted in the plurality of slots 100-1˜100-n, and an interface unit 300 configured to interface a control signal and data between the slots 100-1˜100-n and the control unit 200.

The interface unit 300 includes a plurality of control lines CL1˜CLn of the same number as the number of the slots 100-1˜100-n, and a data bus Dbus of a predetermined number of bits. The number of bits of the data bus Dbus is determined according to the number of service units mounted in each of the respective slots. The operation of the apparatus will be described with reference to an 8-bit data bus for convenience of description. However, other numbers of bits may also be appropriate. In the case of a data bus Dbus of 8 bits, 256 (0˜255) service units can be identified in a slot theoretically, and it is desirable that 254 (1-254) service units are identified except “00000000” and “11111111”.

The respective service units 50-1˜50-n may include unidirectional or bi-directional buffers 51-1˜51-n configured to store its proper ID, so that the control unit 200 can identify the service unit which is mounted in the respective slots 100-1˜100-n.

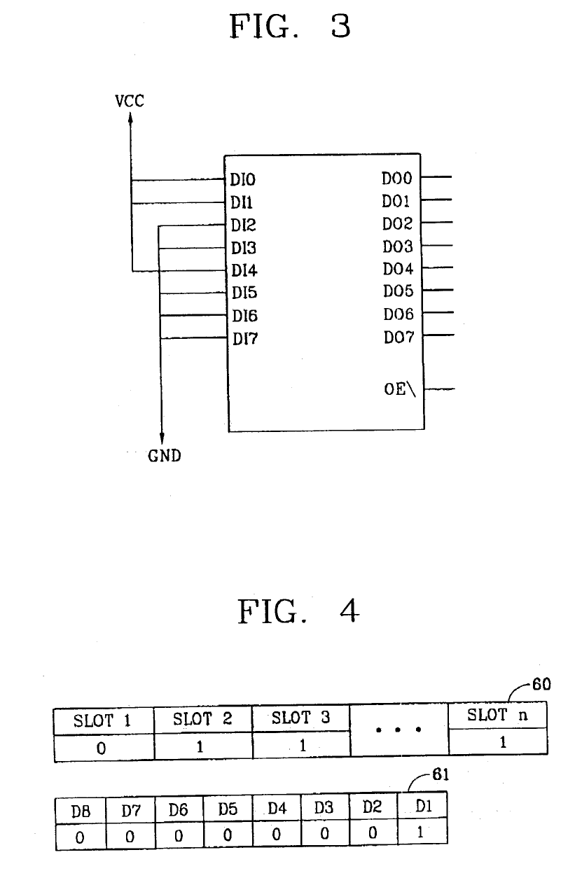

FIG. 3 shows an example of an one way buffer having an input terminal DI0-DI7 of 8 bits, an output terminal DP1-DP7 of 8 bits, and a control terminal /OE. A system designer sets proper IDs for the respective service units 50-1˜50-n by connecting the input terminal DI0-DI7 to a power voltage VCC and/or ground voltage GND, as shown, for example, in FIG. 3.

The control unit 200 includes a PGA 52 that stores the control signal for reading the unit ID and the read unit ID, and a CPU 53 in which a program for performing various controlling operations is stored. As shown in FIG. 4, the PGA 52 includes a first register 60 having slot setting bits for reading the ID of a service unit, and a second register 61 which has storage bits that stores the read ID of the service unit. The slot setting bits of the first setting bits of the first register 60, respectively, correspond to the slots 100-1˜100-n, and the respective bits are set so that they are not simultaneously enabled. Also, when the unit ID stored in the second register 61 is read by the CPU 20, the bit value of the first and second registers 60 and 61 is set to be automatically initialized to “0” or “1”.

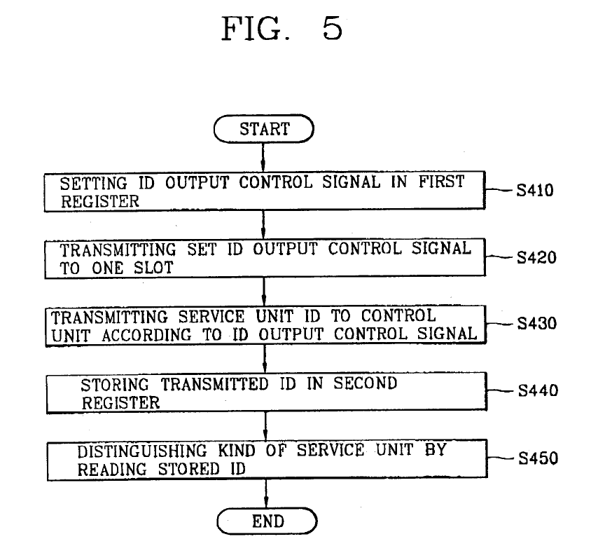

The operation of the apparatus for controlling the service unit of the multi-service system in accordance with an embodiment of the invention will be described with reference to FIGS. 2 to 5. The invention will be described using an example of a case in which only one service unit is mounted in each slot for convenience of description. However, the invention is also applicable to a system in which more than one service unit is mounted in each slot as well as other suitable arrangements.

The CPU 53 of the control unit 200 enables an ID output control signal in the slot setting bit formed in the first register 60 of the PGA 52 corresponding to a respective service unit in order to recognize the kind of the respective service unit mounted in a specific slot in step S410. For instance, in order to recognize the kind of the service unit 50-1 mounted in the slot 100-1, the CPU 53 enables the slot setting bit corresponding to the slot 100-1 in the first register 60 and maintains the other bits as “1”. At this time, the CPU 53 does not enable the other slot setting bits until the enabled slot setting bit is again disabled, in order to prevent the unit ID from being simultaneously read from more than one slot.

When the slot setting bit is enabled in the first register 60, the control unit 200 transmits the low level ID output control signal to the respective service unit, in this example, the service unit 50-1 of the slot 100-1, through the control line CL1 of the interface unit 300 in step S420. As shown in FIG. 3, as the low level ID output control signal is inputted to the output terminal OE\ of the buffer 51-1, the unit ID of 8 bits preset in the buffer 51-1 is transmitted to the control unit 200 by passing through the output terminal DO0-DO7 and the data bus Dbus in step S430.

The transmitted unit ID is stored in the second register 61 in step S440, and the CPU 53 recognizes the kind of the service unit 50-1 mounted in the slot 100-1 by reading the unit ID stored in the second register 61, and performs a controlling operation on the service unit 50-1 in step S450. The CPU 53 reads the unit ID and automatically changes the bit value of the first and second registers 60 and 61 into an initial value.

In the above detailed description of the invention, the case that just one service unit is mounted in each slot was used as an example, however, an identical operation and effect can be also obtained in the case in which a plurality of service units are mounted in each slot.

The apparatus and corresponding method according to the invention have at least the following advantages as well as others.

The apparatus for controlling a service control unit of a multi-service system and a corresponding method is capable of being easily developed in hardware at a low cost. Further, the apparatus and corresponding method according to the invention are capable of efficiently recognizing an ID of a unit regardless of a position and kind of the service unit.

Additionally, the apparatus and corresponding method according to the invention are capable of increasing reusability of software when a system is changed or reconfigured. Also, the apparatus and corresponding method are capable of efficiently recognizing the ID of the service unit which is not controlled by an address bus and data bus.

Further, as described above, the invention stores the service unit ID using an inexpensive two way or one way buffer. Thus, the system is easy to develop with a reduced manufacturing cost in comparison to the prior art. Additionally, since the invention reads the unit ID from the respective slots using only the control signal regardless of the operation and timing of the signal outputted from the control unit, generation of errors in designing the unit can be minimized, and more particularly, reading reliability of the unit ID can be improved.

Also, since the invention recognizes the service unit on the basis of the unit ID stored in the register, regardless of the address of the respective slot or PGA address of the unit, reusability of software can be increased in the case that the register composition of the control unit is consistently used even if the system is changed. Additionally, the invention can be more efficient in the case of different systems which share a kind of service unit by setting a proper ID in a plurality of units using a two way buffer and consistently managing the unit ID. Further, the invention can read the ID of the units, which cannot be controlled by the address and data bus, by controlling the service unit through the control line and data bus.

The foregoing embodiments and advantages are merely exemplary and are not to be construed as limiting the invention. The present teaching can be readily applied to other types of apparatuses. The description of the invention is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures.

What is claimed is:

1. An apparatus for controlling a service control unit of a multi-service system, comprising:
one or more slots;
at least one service unit mounted in each of the one or more slots;
a control unit configured to read an ID of a respective service unit and individually control the respective service unit; and
an interface unit configured to interface a control signal and unit ID between the one or more slots and the control unit.

2. The apparatus of claim 1, wherein the one or mote slots comprise a plurality of slots and at least one service unit is mounted in each of the plurality of slots.

3. The apparatus of claim 1, wherein each service unit includes a buffer configured to store a respective ID of the service unit.

4. The apparatus of claim 3, wherein the buffer is an unidirectional buffer or bi-directional buffer.

5. The apparatus of claim 2, wherein the interface unit includes:
a plurality of control lines which are connected, respectively, to the plurality of slots; and
a data bus of predetermined bits which is commonly connected to the plurality of slots.

6. The apparatus of claim 5, wherein the bit of the data bus is determined by the number of service units.

7. The apparatus of claim 1, wherein the control unit includes:
a programming gate array (PGA) configured to transmit an ID output control signal of a service unit to a respective slot and to store the ID outputted from the respective slot; and
a CPU configured to enable an output control signal of the ID in the PGA and to distinguish the respective service unit by reading the ID stored in the PGA.

8. The apparatus of claim 7, wherein the PGA includes:
a first register comprising a plurality of slot setting bits corresponding to the respective slots and configured to store the ID output control signal for each of the respective service units; and
a second register configured to store the ID read in the respective service unit.

9. The apparatus of claim 8, wherein the first and second registers are automatically initialized when the CPU reads the ID stored in the second register.

10. The apparatus of claim 9, wherein the respective slot setting bits of the first register are not simultaneously enabled.

11. An apparatus for controlling a service control unit of a multi-service system, comprising:
a plurality of slots in which a service unit is mounted;
at least one service unit mounted in each of the plurality of slots;
a plurality of control lines individually connected, respectively, to the plurality of slots;
a data bus commonly connected to each of the plurality of slots; and
a control unit configured to control the at least one service unit mounted in each of the plurality of slots through the control lines and the data bus.

12. The apparatus of claim 11, wherein each service unit includes a unidirectional buffer or bi-directional buffer configured to store a respective ID for the service unit

13. The apparatus of claim 12, wherein each service unit is connected to the respective control line of its respective slot.

14. The apparatus of claim 11, wherein the control unit includes:
a programmable gate array (PGA) configured to transmit an ID output control signal to a respective service unit of a respective slot through its respective control line and configured to store the ID transmitted from the respective service unit through the data bus; and
a CPU configured to enable an ID output control signal of the respective service unit and to distinguish the service unit by reading the ID stored in the PGA.

15. The apparatus of claim 14, wherein the PGA includes:
a first register comprising a plurality of slot setting bits corresponding to the respective slots and configured to store the ID output control signal for each of the respective service units; and
a second register configured to store the ID transmitted by the respective service unit.

16. The apparatus of claim 15, wherein the first and second registers are automatically initialized when a CPU reads the ID stored in the second register.

17. The apparatus of claim 16, wherein the respective slot setting bits of the first register are not simultaneously enabled.

18. A method for controlling a service control unit of a multi-service system, comprising:
enabling an ID output control signal in a first register of a control unit;
transmitting the enabled ID output control signal to a slot containing a service unit;
transmitting an ID of the service unit to the control unit according to the transmitted ID output control signal;
storing the transmitted ID in a second register of the control unit; and
controlling the corresponding service unit by reading the stored ID.

19. The method of claim 18, further comprising:
initializing the first and second registers after reading the stored ID.

20. The method of claim 18, further comprising storing the service unit ID in a buffer of the service unit.

21. The method of claim 20, wherein the buffer is a unidirectional buffer or bi-directional buffer.

22. The method of claim 18, wherein the step of transmitting the enabled ID output control signal to a slot containing a service unit comprises transmitting the ID output control signal through a control line which is connected to the slot.

23. The method of claim 18, wherein the first register includes a slot setting bit corresponding to the slot, and the ID output control signal of the service unit is stored in the respective slot setting bit.

24. The method of claim 23, wherein the ID output control signal is simultaneously set in two bits.

25. A method for controlling service control units of a multi-service system, the multi-service system including a plurality of slots, each containing one or more service units, and a control unit, the method comprising:
enabling an ID output control signal stored in the control unit;
transmitting the enabled ID output control signal to a respective slot;
transmitting an ID of a respective service unit corresponding to the ID output control signal to the control unit;
storing the transmitted ID in the control unit; and
controlling the respective service unit by reading the ID.

26. The method of claim 25, wherein the ID output control signal is stored in a first register in the control unit, and the transmitted ID is stored in a second register of the control unit.

27. An apparatus for controlling service control units of a multi-service system, the multi-service system including a plurality of slots, each containing one or more service units, the apparatus comprising:
means for enabling an ID output control signal;
means for transmitting the enabled ID output control signal to a respective slot;
means for transmitting an ID of a respective service unit corresponding to the ID output control signal to the control unit;
means for storing the transmitted ID; and
means for controlling the respective service unit by reading the ID.
